(19) United States
(12) Patent Application Publication
(10) Pub. No.: US 2009/0290177 A1
(43) Pub. Date: Nov. 26, 2009

(54) Image forming apparatus

(75) Inventors: Hiromasa Shibano, Osaka (JP); Michiaki Nishimura, Osaka (JP); Kenji Tanaka, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/453,406

(22) Filed: May 11, 2009

(30) Foreign Application Priority Data
May 21, 2008 (JP) 2008-132631

(51) Int. Cl. H04N 1/60

(52) U.S. Cl. 358/1.9

(57) ABSTRACT

An image forming apparatus, that is controlled to perform image output based on electrophotography, includes: an image processor for outputting input image information in the form of image data for forming images; and, an image forming portion for forming images on a sheet of paper based on the image data output from the image processor. The image processor has a function which, in accordance with folding information for folding the paper with images formed thereon, sets the images to be formed on the page of the folded paper whose folded sections oppose each other when the paper has been folded.

This Nonprovisional application claims priority under 35 U.S.C. §119(a) on Patent Application No. 2008-132631 filed in Japan on 21 May 2008, the entire contents of which are hereby incorporated by reference.

### BACKGROUND OF THE INVENTION

(1) Field of the Invention

The present invention relates to an image forming apparatus, in particular, relating to an image forming apparatus that is controlled to perform image output based on electrophotography.

(2) Description of the Prior Art

Recently, image forming apparatuses such as copiers, facsimile machines and the like, are configured to be able to easily perform image output by remote control from external devices such as PC terminals and the like. The documents output from the image forming apparatus can be usually stacked on the paper output tray and collected in a simple manner.

However, the documents on this paper output tray are exposed to the state in which any one can easily pick them up or any one can easily look the recorded content of the documents.

Under such circumstances, conventionally there has been a proposal of an image forming apparatus having the function of preventing illegal copy in order that an original copy and output copy will not be duplicated. For example, in order to permit an original to be copied or prohibit an original from being copied, in addition to inherent information on the original, a copy prohibition mark or copy permission mark which is generated by patterning copy prohibiting information or copy permitting information is added so as to enable distinction of the validity of the mark contained in the image of the read original, whereby it is possible to exactly determine whether duplication is permitted or prohibited, and thereby provide a higher copy guard function (see patent document 1: Japanese Patent Application Laid-open No. 2006-157742).

However, the above conventional technique merely prevents illegal copy of originals by adding information for original copy permission or prohibition. That is, there is the problem that the above configuration cannot prevent information leakage as a result of the content recorded on the document being easily seen.

### SUMMARY OF THE INVENTION

The present invention has been devised in view of the above conventional problem, it is therefore an object of the present invention to provide an image forming apparatus which can prevent information leakage by making it difficult to look particular information recorded on the output paper from the image forming apparatus.

The image forming apparatus according to the present invention to solve the above problem is configured as follows:

The first aspect of the present invention resides in an image forming apparatus that is controlled to perform image output based on electrophotography, comprising: an image processor for outputting input image information in the form of image data for forming images; and, an image forming portion for forming images on recording paper based on the image data output from the image processor, characterized in that the image processor has a function which, in accordance with folding information for folding recording paper with images formed thereon, sets the images to be formed on the page of the folded recording paper whose folded sections oppose each other when the recording paper has been folded.

In the second aspect of the present invention, it is preferable that the folding information is information for folding the recording paper in two.

In the third aspect of the present invention, it is preferable that the folding information is information for folding the recording paper in three. Here, in the present invention, examples of folding the recording paper in three may include a case in which one half of a two-folded recording sheet is further folded outside in two.

In the fourth aspect of the present invention, it is preferred that, in addition to the configurations of the first to third aspects, the images formed on the page of the folded recording paper whose folded sections oppose each other is based on particular image information of the image information input to the image processor. Here in the present invention, examples of the particular image information may include important information compared to usually formed images, information of confidentiality such as in-house information, inside information, personal information and the like.

In the fifth aspect of the present invention, it is preferred that, in addition to the configurations of the first to third aspects, the images formed on the page of the folded recording paper whose folded sections oppose each other is based on the image information obtained from an external device.

In the sixth aspect of the present invention, it is preferred that, in addition to the configurations of the first to fourth aspects, the image processor has a function of adding copy restraint information to the page of the folded recording paper whose folded sections oppose each other.

In the seventh aspect of the present invention, it is preferred that, in addition to the configurations of the first to fourth aspects, the image processor has a function of adding copy prohibition information to the page of the folded recording paper whose folded sections oppose each other.

In the eighth aspect of the present invention, it is preferred that, in addition to the configurations of the first to seventh aspects, the image forming apparatus further includes a folding mechanism for folding the recording paper after image forming.

According to the first aspect of the present invention, when recording paper is folded based on folding information, the image information recorded on the page of the recording paper whose folded sections oppose each other after folding becomes unseen from the outside. As a result, it is possible to make the recorded image information on recording paper unlikely to be easily looked, hence it is possible to prevent leakage of information recording on the recording paper and improve security.

According to the second aspect of the present invention, when, for example, one-sided printing is performed in the image forming apparatus, it is possible to make the image information recorded on the printed page unseen by folding the recording paper in two so that the printed page is positioned inside.

According to the third aspect of the present invention, when, for example, duplex printing (on front and reverse sides) is performed in the image forming apparatus, it is possible to make the image information recorded in the designated sections on the front side printed page unseen from the outside, by folding the recording paper in two so that the front side printed page is positioned inside. Further, it is possible to make the image information recorded in the designated sections on the rear side printed page unseen from the outside by further folding one half of the two-folded recording sheet in two, outwardly.

According to the fourth aspect of the present invention, in addition to the effects of the first to third aspects, since important information compared to usually formed images, information of confidentiality such as in-house information, inside information, personal information etc., can be arranged on the folded page that is positioned inside, it is possible to improve security.

According to the fifth aspect of the present invention, in addition to the effects of the first to third aspects, it is possible to take in image information easily.

According to the sixth aspect of the present invention, in addition to the effects of the first to fourth aspects, it is possible to further improve security.

According to the seventh aspect of the present invention, in addition to the effects of the first to fourth aspects, it is possible to further improve security.

According to the eighth aspect of the present invention, in addition to the effects of the first to seventh aspects, it is possible to output the recording paper from the image forming apparatus in such a condition that the recording paper is folded. As a result, it is possible to make the image information recorded on the recording paper difficult to be seen, hence it is possible to prevent leakage of information recorded in the recording paper and improve security.

### BRIEF DESCRIPTION OF THE DRAWINGS

FIG. 1 is an illustrative view showing the overall configuration of an image forming apparatus according to the embodiment of the present invention;

FIG. 2 is a partially detailed view showing the configuration of the apparatus body of the image forming apparatus;

FIG. 3 is a partially detailed view showing the configuration of branched paper feed paths for the paper conveyor arrangement in the image forming apparatus and branch guides for connecting these paths;

FIG. 4 is a block diagram showing an electric control configuration of the image forming apparatus;

FIG. 5 is a schematic view showing the configuration of a folding machine and a finisher equipped to the image forming apparatus;

FIG. 6 is a perspective view showing one status example of an output sheet that is folded in accordance with a middle folding command in the image forming apparatus;

FIG. 7 is an illustrative view showing image forming areas on a sheet of paper based on middle folding information in the image forming apparatus;

FIG. 8 is a perspective view showing one status example of an output sheet of paper that is folded in accordance with a z-folding command in the image forming apparatus;

FIG. 9 is an illustrative view showing image forming areas on a sheet of paper based on z-folding information in the image forming apparatus; and,

FIG. 10 is a plan view showing a state of the sheet being folded.

### DESCRIPTION OF THE PREFERRED EMBODIMENTS

The embodiment of the present invention will hereinafter be described in detail with reference to the accompanying drawings.

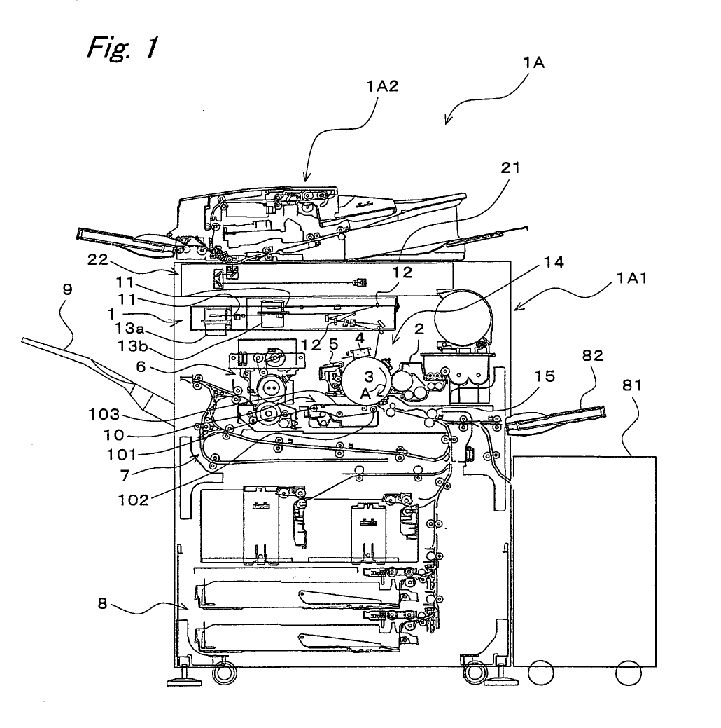

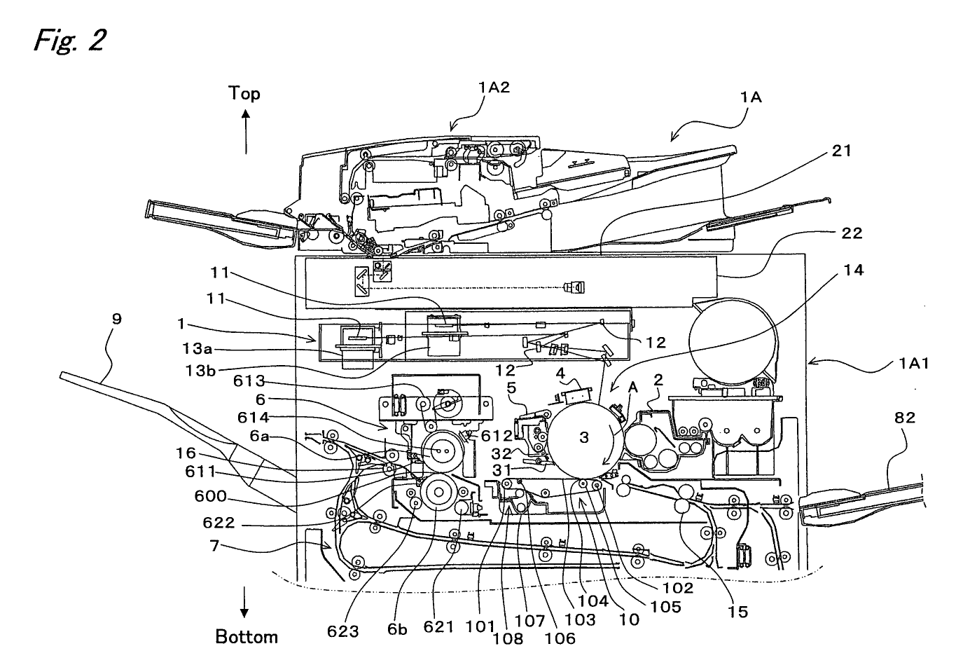

FIG. 1 is an illustrative view showing the overall configuration of an image forming apparatus according to the embodiment of the present invention. FIG. 2 is a partially detailed view showing the configuration of the apparatus body of the same image forming apparatus.

An image forming apparatus 1A according to the present embodiment is controlled so as to perform image output based on electrophotography, and includes an image processor for outputting input image information in the form of image data; and an image forming portion for forming images on recording paper based on the image data output from the image processor. Further, the image processor has a function which, in accordance with folding information for folding recording paper with images formed thereon, sets the images to be formed on the page of the folded recording paper whose folded sections oppose each other when the recording paper has been folded.

To begin with, the overall configuration of image forming apparatus 1A according to the present embodiment will be described with reference to the drawings.

Image forming apparatus 1A according to the present embodiment electrophotographically forms and outputs a monochrome image of image data that was transferred from without, on a predetermined sheet-like recording paper (to be referred to hereinbelow as paper) as a recording medium.

Image forming apparatus 1A is essentially composed of, as shown in FIGS. 1 and 2, an apparatus body 1A1 including a light exposure unit 1, a developing device 2, a photoreceptor drum 3, a charger 4, a cleaner unit 5, a fusing unit 6, a paper conveyor arrangement 7, a paper feed tray 8, a paper output tray 9, a transfer device 10 and the like, and an automatic document processor 1A2.

Formed on the top surface of apparatus body 1A1 is an original placement table 21 made of transparent glass on which a document is placed. Automatic document processor 1A2 is arranged on the top of this original placement table 21 so that it can pivotally open upwards while a scanner portion 22 as a document reader for reading image information of originals is laid out under this original placement table 21.

Arranged below scanner portion 22 are light exposure unit 1, developing device 2, photoreceptor drum 3, charger 4, cleaner unit 5, fusing unit 6, paper conveyor arrangement 7, paper output tray 9 and transfer device 10. Further, paper feed tray 8 that accommodates paper is arranged under these.

Light exposure unit 1 provides a function of emitting laser beam in accordance with the image data (printing image information) output from an unillustrated image processor to irradiate the photoreceptor drum 3 surface that has been uniformly charged by charger 4 so as to write and form an electrostatic latent image corresponding to the image data on the photo receptor drum 3 surface. This light exposure unit 1 is arranged directly under scanner portion 22 and above photoreceptor drum 3, and includes laser scanning units (LSUs) 13a and 13b each having a laser emitter 11 and a reflection mirror 12. In the present embodiment, in order to achieve high-speed printing operation, a method for alleviating a rush of irradiation timings by using a multiple number of laser beams, namely a two-beam method, is adopted.

Here, in the present embodiment laser scanning units (LSUs) 13a and 13b are used for light exposure unit 1, but an array of light emitting elements, e.g., an EL or LED writing head may also be used.

As shown in FIG. 2, photoreceptor drum 3 has an approximately cylindrical shape, is arranged under light exposure unit 1 and is controlled so as to rotate in a predetermined direction (in the direction of arrow A in the drawing) by an unillustrated drive means and control means. Arranged starting from the position at which image transfer ends downstream in the rotational direction of the photoreceptor drum along the peripheral surface of this photoreceptor drum 3 are a paper separation claw (recording medium separator) 31, cleaner unit 5, charger 4 as an electric field generator and developing unit 2 in the order mentioned.

Paper separation claw 31 is disposed so as to be moved into and out of contact with the outer peripheral surface of photoreceptor drum 3 by means of a solenoid (separator drive means) 32. When this paper separation claw 31 is put in abutment with the outer peripheral surface of photoreceptor drum 3, it functions to peel off the paper, which has adhered to the photoreceptor drum 3 surface during the unfixed toner image on photoreceptor drum 3 being transferred to the paper. Here, as a drive means for paper separation claw 31, a drive motor may be used instead of solenoid 32, or any other drive means may be also selected.

Developing unit 2 visualizes the electrostatic latent image formed on photoreceptor drum 3 with black toner, and is arranged at approximately the same level at the side (on the right side in the drawing) of photoreceptor drum 3 downstream of charger 4 with respect to the rotational direction of the photoreceptor drum (in the direction of arrow A in the drawing). A registration roller 15 is disposed under this developing unit 2 on the upstream side with respect to the recording medium feed direction.

Registration roller 15 is operated and controlled by an unillustrated drive means and control means so as to convey the paper delivered from paper feed tray 8 into and between photoreceptor drum 3 and a transfer belt 103 whilst making the leading end of the paper register with the image area on the photoreceptor drum 3.

Charger 4 is a charging means for uniformly charging the photoreceptor drum 3 surface at a predetermined potential, and is arranged over photoreceptor drum 3 and close to the outer peripheral surface thereof. Here, a discharge type charger 4 is used in the present embodiment, but a contact roller type or a brush type may be used instead.

Cleaner unit 5 removes and collects the toner left on the surface of photoreceptor drum 3 after development and image transfer, and is disposed at approximately the same level at the side of photoreceptor drum 3 (on the left side in the drawing), on the approximately opposite side across photoreceptor drum 3 from developing unit 2.

As described above, the visualized electrostatic image on photoreceptor drum 3 is transferred to the paper whilst the paper is being conveyed and applied from transfer device 10 with an electric field having an opposite polarity to that of the electric charge of the electrostatic image.

For example, when the electrostatic image bears negative (−) charge, the applied polarity of transfer device 10 should be positive (+).

As shown in FIG. 2, transfer device 10 is provided as a transfer belt unit form in which a transfer belt 103 having a predetermined resistivity (ranging from 1×10⁹ to 1×10¹³Ω·cm in the embodiment) is wound and tensioned on a drive roller 101, a driven roller 102 and other rollers, and is disposed under photoreceptor drum 3 with the transfer belt 103 surface put in contact with part of the outer peripheral surface of photo receptor drum 3. This transfer belt 103 conveys the paper while pressing it against photoreceptor drum 3.

An elastic conductive roller 105 having a conductivity different from that of drive roller 101 and driven roller 102 and capable of applying a transfer electric field is laid out at a contact point 104 where transfer belt 103 comes into contact with photoreceptor drum 3. Elastic conductive roller 105 is composed of a soft material such as elastic rubber, foamed resin etc. Since this elasticity of elastic conductive roller 105 permits photoreceptor drum 3 and transfer belt 103 to come into, not line contact, but area contact of a predetermined width (called a transfer nip) with each other, it is possible to improve the efficiency of transfer to the paper being conveyed.

Further, a charge erasing roller 106 for erasing the electric field that has been applied to the paper being conveyed through the transfer area so as to achieve smooth conveyance of the paper to the subsequent stage is disposed on the interior side of transfer belt 103, on the downstream side, with respect to the direction of paper conveyance, of the transfer area of transfer belt 103.

Transfer device 10 also includes a cleaning unit 107 for removing soil due to leftover toner on transfer belt 103 and a plurality of charge erasing devices 108 for erasing electricity on transfer belt 103. Erasure of charge by erasing devices 108 may be performed by grounding via the apparatus or by positively applying charge of a polarity opposite to that of the transfer field.

The paper with the electrostatic image (unfixed toner) transferred thereon by transfer device 10 is conveyed to fusing unit 6, where it is pressed and heated so as to fuse and fix the unfixed toner to the paper. Fusing unit 6 includes a heat roller 6a and a pressing roller 6b as shown in FIG. 2 and fuses and fixes the toner image transferred on the paper by rotating heat roller 6a so as to convey the paper held between heat roller 6a and pressing roller 6b through the nip between heat roller 6a and pressing roller 6b. Arranged on the downstream side of fusing unit 6 with respect to the direction of paper conveyance is a conveyance roller 16 for conveying paper.

Heat roller 6a has a sheet separation claw 611, a roller surface temperature detector (thermistor) 612 and a roller surface cleaning member 613, all arranged on the outer periphery thereof and a heat source 614 for heating the heat roller surface at a predetermined temperature (set fixing temperature: approximately 160 to 200 deg. C.) provided in the interior part thereof.

Pressing roller 6b is provided at its each end with a pressing element 621 capable of abutting pressing roller 6b with a predetermined pressure against heat roller 6a. In addition a sheet separation claw 622 and a roller surface cleaning element 623 are provided on the outer periphery of pressing roller 6b, similarly to the outer periphery of heat roller 6a.

In this fusing unit 6, as shown in FIG. 2 the unfixed toner on the paper being conveyed is heated and fused by heat roller 6a, at the pressed contact (so-called fixing nip portion) 600 between heat roller 6a and pressing roller 6b, so that the unfixed toner is fixed to the paper by its anchoring effect to the paper by the pressing force from heat roller 6a and pressing roller 6b.

Paper feed tray 8 stacks a plurality of sheets (paper) to which image information will be output (printed), and is arranged under image forming portion 14 made up of light exposure unit 1, developing unit 2, photoreceptor drum 3, charger 4, cleaner unit 5, fusing unit 6, etc. An unillustrated paper pickup roller is disposed over the paper delivery side of this paper feed tray 8.

This paper pickup roller picks up one sheet of paper at a time from the topmost of a stack of paper stored in paper feed tray 8, and conveys the paper downstream (for convenience′ sake, the delivery side of paper (the cassette side) is referred to as upstream and the paper output side is referred to as downstream) to the registration roller (also called “idle roller”) 15 side on paper conveyor arrangement 7.

Since the image forming apparatus 1A according to the present embodiment is aimed at performing high-speed printing operations, a multiple number of paper feed trays 8 each capable of stacking 500 to 1500 sheets of standard-sized paper are arranged under image forming portion 14. Further, a large-capacity paper feed cassette 81 capable of storing multiple kinds of paper in large volumes is arranged at the side of the apparatus while a manual feed tray 82 for essentially supporting printing etc. for irregular sized paper is arranged on the top of the large-capacity paper feed cassette 81.

Paper output tray 9 is arranged on the opposite side across the apparatus from that of manual feed tray 82. It is also possible to configure such a system that instead of paper output tray 9, a finisher for output paper (apparatus for stapling, punching and the like) and/or a multi-bin paper output tray etc., can be arranged optionally.

Paper conveyor arrangement 7 is laid out between the aforementioned photoreceptor drum 3 and paper feed tray 8, and conveys the paper supplied from paper feed tray 8, sheet by sheet, to transfer device 10, where a toner image is transferred from photoreceptor drum 3 to the paper, further conveying the paper to fusing unit 6 where the unfixed toner image is fixed to the paper, then convey the paper as it is being guided by paper feed paths and branch guides, in accordance with the designated paper output processing mode.

Now, paper conveyor arrangement 7 will be described in detail with reference to the drawings.

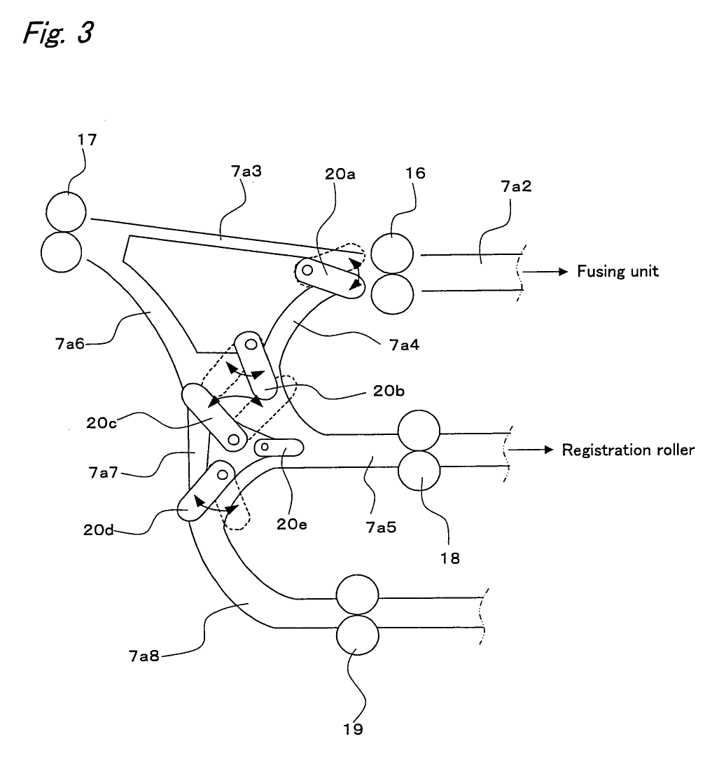

FIG. 3 is a partially detailed view showing the configuration of branched paper feed paths for the paper conveyor arrangement in the image forming apparatus and branch guides for connecting these paths.

Paper conveyor arrangement 7 is essentially composed of a first paper feed path extending from paper feed tray 8 to registration roller 15 shown in FIGS. 1 and 2, a second paper feed path 7a2 extending from registration roller 15 and passing through transfer device 10 and fusing unit 6 to a conveyance roller 16 on the downstream side, a third paper feed path 7a3 extending from conveyance roller 16 to a paper discharge roller 17 for discharging paper to paper output tray 9, a fourth paper feed path 7a4 for inverting paper P from conveyance roller 16, a fifth paper feed path 7a5 connected to fourth paper feed path 7a4 and extending to an inversion conveyance roller 18 for re-feeding paper P to registration roller 15, a sixth paper feed path 7a6 for conveying paper P in reverse from paper discharge roller 17, a seventh paper feed path 7a7 connected to the sixth paper feed path and avoiding entrance to fifth paper feed path 7a5 and an eighth paper feed path 7a8 connected to seventh paper feed path 7a7 and extending to a switchback roller 19, all these paths being shown in FIG. 3.

Further, a plurality of branch guides for switching the route of paper conveyance by selecting the paper feed paths of paper P in accordance with the selected processing mode are arranged at branch points inside paper conveyor arrangement 7.

A branch guide 20a that selects connection to third paper feed path 7a3 or fourth paper feed path 7a4 is pivotably arranged at a point downstream of conveyance roller 16. This branch guide 20a is operated by an unillustrated solenoid.

A branch guide 20b is pivotably arranged on the downstream side of fourth paper feed path 7a4 so as to connect fourth paper feed path 7a4 with fifth paper feed path 7a5 or fifth paper feed path 7a5 with sixth paper feed path 7a6. This branch guide 20b is operated by the elastic force of an unillustrated spring member and the rigidity of paper P.

A branch guide 20c is pivotably arranged on the downstream side of sixth paper feed path 7a6 so as to select connection to fifth paper feed path 7a5 or seventh paper feed path 7a7. This branch guide 20c is operated by an unillustrated solenoid.

A branch guide 20d is pivotably arranged on the downstream side of seventh paper feed path 7a7 so as to connect seventh paper feed path 7a7 with eighth paper feed path 7a8 or fifth paper feed path 7a5 with eighth paper feed path 7a8. This branch guide 20d is operated by an unillustrated solenoid.

A branch guide 20e for assuring smooth connection from fourth paper feed path 7a4 or eighth paper feed path 7a8 to fifth paper feed path 7a5 is pivotably arranged on the upstream side of fifth paper feed path 7a5.

With the thus configured paper conveyor arrangement 7, branch guides 20a to 20d are operated in accordance with the requested processing mode, whereby it is possible to select a conveyance route of paper P corresponding to the processing mode.

Next, the paper conveyance operations corresponding to processing modes of image forming apparatus 1A will be described with reference to the drawings.

Paper P that corresponds to a print request is selected from a multiple number of paper feed trays 8 and is conveyed by conveyance rollers in paper conveyor arrangement 7 to registration roller 15.

The paper P that has reached registration roller 15 and is temporarily suspended is delivered to transfer device 10 by restarting rotation of registration roller 15 at such a timing as to make the leading end of paper P register with the image information on the photoreceptor drum 3, whereby the unfixed toner image (image information) is transferred from photoreceptor drum 3 to paper P, then the toner image is fixed to the paper P by fusing unit 6 and the paper is discharged to paper output tray 9.

With this paper conveyor arrangement 7, different routes of conveyance are taken after fusing unit 6 up to paper output tray 9, depending on the functional modes (copy mode, printer mode, FAX mode) of image forming apparatus 1A and the print processing modes (one-sided printing, duplex printing).

In copier mode, the user usually operates the image forming apparatus 1A on site, so that the paper is generally adapted to be output “faceup”, that is, the paper is discharged with its printed face up.

In contrast, in the printer and FAX modes, the user is not present near image forming apparatus 1A, so the paper is generally adapted to be output “facedown”, that is, the sheets of paper P is discharged in the collated order.

Accordingly, image forming apparatus 1A is configured so that the paper P having passed through fusing unit 6 is conveyed along multiple conveyance paths through multiple branch guides and output to paper output tray 9 in the function-oriented manner.

(Faceup Output with One-Sided Printing)

In image forming apparatus 1A, in an output mode in which paper P is printed on its one side and discharged faceup, immediately before the paper P having passed through fusing unit 6 enters conveyance roller 16, branch guide 20a is actuated by an unillustrated guide position changeover means (solenoid etc.) to open third paper feed path 7a3 and close fourth paper feed path 7a4.

The paper P being conveyed advances with its leading part navigated by branch guide 20a, passing through third paper feed path 7a3 and is discharged by means of paper discharge roller 17 to paper output tray 19.

(Facedown Output with One-Sided Printing)

In image forming apparatus 1A, in an output mode in which paper P is printed on its one side and discharged facedown, immediately before the paper P having passed through fusing unit 6 enters conveyance roller 16, branch guide 20a is actuated by an unillustrated guide position changeover means (solenoid etc.) to open fourth paper feed path 7a4 and close third paper feed path 7a3. Further, branch guide 20c is actuated by an unillustrated guide position changeover means to open fifth paper feed path 7a5 and close seventh paper feed path 7a7.

The paper P being conveyed advances with its leading part navigated by branch guide 20a, passing through fourth paper feed path 7a4 and pushes away branch guide 20b by the rigidity of the leading end of paper P and conveyance force to open fifth paper feed path 7a5, then is navigated by branch guide 20c into fifth paper feed path 7a5.

When the rear end of paper P reaches the position of branch guide 20e, conveyance of paper P is temporarily suspended.

Branch guide 20c is actuated by an unillustrated guide position changeover means to open sixth paper feed path 7a6 and close seventh paper feed path 7a7. At this time, branch guide 20b moves by itself by an elastic member (spring etc.) disposed on an unillustrated branch guide support shaft so as to close fourth paper feed path 7a4.

Then, inversion conveyance roller 18 rotates in reverse so as to restart conveyance of paper P. The paper P being conveyed advances with its rear end residing at the position of branch guide 20e first, passing through sixth paper feed path 7a6 and is output by way of paper discharge roller 17 to paper output tray 9.

### (Output in Duplex Printing Mode)

When duplex printing is performed in image forming apparatus 1A, immediately before the paper P having the first print face (front sideprint) printed and passed through fusing unit 6 enters conveyance roller 16, branch guide 20a is actuated by an unillustrated guide position changeover means (solenoid etc.) to open fourth paper feed path 7a4 and close third paper feed path 7a3.

Further, branch guide 20c is actuated by an unillustrated guide position changeover means to open seventh paper feed path 7a7 and close fifth paper feed path 7a5. Branch guide 20d is also actuated by an unillustrated guide position changeover means to open eighth paper feed path 7a8.

The paper P being conveyed advances with its leading part navigated by branch guide 20a, passing through fourth paper feed path 7a4 and pushes away branch guide 20b by the rigidity of the leading end of paper P and conveyance force, then is navigated by branch guide 20c to be lead to seventh paper feed path 7a7 and further to eighth paper feed path 7a8.

When the rear end of paper P arrives at eighth paper feed path 7a8, conveyance of paper P is temporarily suspended (the completion of the first page switchback). Thereafter, as branch guide 20d is actuated by an unillustrated guide position changeover means to close seventh paper feed path 7a7 and open the conveyance path to branch guide 20e, switchback roller 19 rotates in reverse to restart conveyance of paper P.

The paper P being conveyed advances with its rear end residing at the position in eighth paper feed path 7a8 first, passing through branch guide 20e and fifth paper feed path 7a5, and is conveyed to registration roller 15 which is located right before the printing stage (transfer step in the transfer device).

Thereafter, the second page printing of paper P (rear side printing) is performed. The paper P then passes through fusing unit 6 and is conveyed in the same manner as described in the above “Faceup output with one-sided printing” section and discharged to paper output tray 9.

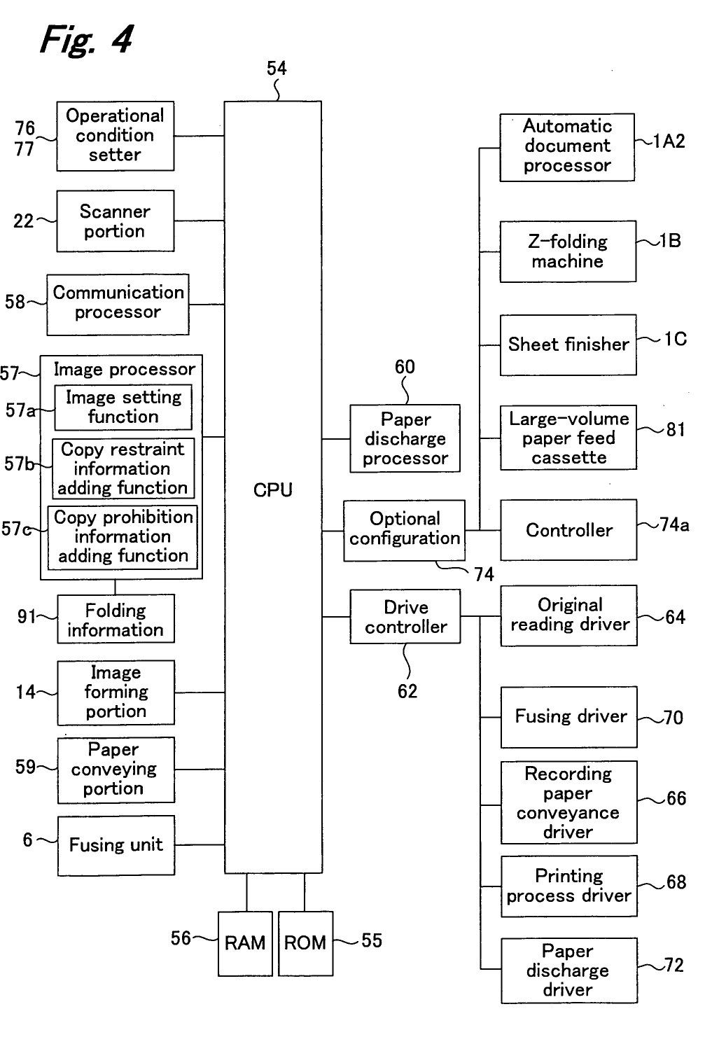

Next, the control system of image forming apparatus 1A characterizing the present embodiment will be described in detail with reference to FIG. 4.

FIG. 4 is a block diagram showing an electric controller configuration of the image forming apparatus according to the present embodiment.

As shown in FIG. 4, image forming apparatus 1A according to the embodiment executes processes such as image reading, image processing, image forming and conveyance of paper P, etc., by a central processing unit (CPU) 54 which performs control in accordance with the program stored beforehand in a ROM (read only memory) 55, using temporal storage such as a RAM (random access memory) 56 etc.

Here, it is also possible to use other storage means such as a HDD (hard disk drive) etc., instead of ROM 55 and RAM 56.

In image forming apparatus 1A, the image information of an original (original image data) captured by scanner portion (original reading portion) 22, or original image information transmitted from other terminal devices connected on an unillustrated communication network, is adapted to be input to an image processor 57 by way of a communication processor 58.

Image processor 57 shapes the original image information stored in the storage such as RAM 56 or the like into a printing image that is suited to printing (image forming onto recording paper), in accordance with the aforementioned program. The printing image information output from image processor 57 is input to image forming portion 14.

Image forming portion 14, paper conveying portion (performing various detections and controls of the paper in paper conveyor arrangement 7 etc.), fusing unit 6 and paper discharge processor (performing various detections and controls of the paper in paper discharge path 17) 60 are linked with respective components of drive controller 62.

Image forming apparatus 1A further has an operational condition setter 77. This operational condition setter 77 sets up operational conditions for image forming and conditions of conveyance etc., in image forming apparatus 1A, in accordance with the image forming request and the image forming conditions such as the type of recording media (paper) etc., designated by the user through control switches 76.

Further, in image forming apparatus 1A, based on the set operating conditions, drive controller 62 controls the drive actuators for the reading portion (scanner portion 22), paper conveying portion 59, image forming portion 14, fusing unit 6, paper discharge processor 60 etc., namely, an original reading driver 64, a recording paper conveyance driver 66, a printing process driver 68, a fusing driver 70 and a paper discharge driver 72 so that they can operate in synchronization following instructions from CPU 54 in accordance with the program stored in ROM 55.

Further, image forming apparatus 1A may be used with optional configurations 74 including a folding machine 1B, a finisher (stapler, puncher, multi-bin paper output trays, shifter, etc.) 1C, automatic document reader (automatic document processor 1A2 etc.), large-volume paper feed cassette 81 and the like. These optional configurations 74 incorporate individual controllers 74a separately from the controller of image forming apparatus 1A so that each processor can operate in synchronization with the main apparatus by performing timing adjustment via the aforementioned communication processor 58.

As the characteristic configuration of image forming apparatus 1A of the present embodiment, image processor 57, in addition to the above-described functions, has an image setting function 57a which, in accordance with folding information 91 for folding paper formed with images, sets images to be formed on the page of a sheet of paper whose folded sections oppose each other when the paper has been folded, or on the page that will be arranged inside when the paper has been folded.

This folding information 91 may be set, for example, by input through control switches 76 in operational condition setter 77, or may be input from an external device. Specific examples of folding information may include folding information for folding the paper after image formation in two or in three (so called z-folding).

That is, since the sections (on the first page) that are located inside when the paper is folded vary depending on the way in which the paper is folded, image processor 57 of the present embodiment sets up image layout in accordance with the folding information on the paper so that among image information input to image processor 57, images based on particular image information will be arranged on the interior side of the paper, and outputs the image information (image data) for printing to image forming portion 14. This particular image information may include important information compared to usually formed images, information of confidentiality such as in-house information, inside information, personal information, etc.

Accordingly, image processor 57 of the present embodiment lays out particular image information in the interior sections (on the first page) when the paper is folded, and image forming portion 14 performs image output based on the image data output from image processor 57, whereby it is possible to make the particular image information not directly seen from the outside, hence improve security.

Further, image processor 57 has a copy restraint information adding function 57b for adding copy restraint information to the opposing page sections (on the first page) of the aforementioned folded paper and a copy prohibition information adding function 57c for copy prohibition information.

This configuration makes it possible for image processor 57 of the present embodiment to restrain copying of the paper or prohibit copying even if the particular image information printed on the paper is looked accidentally, it is hence possible to further improve security.

Next, the paper discharge process when folding machine 1B and finisher 1C are equipped to image forming apparatus 1A of the present embodiment will be described with reference to the drawings.

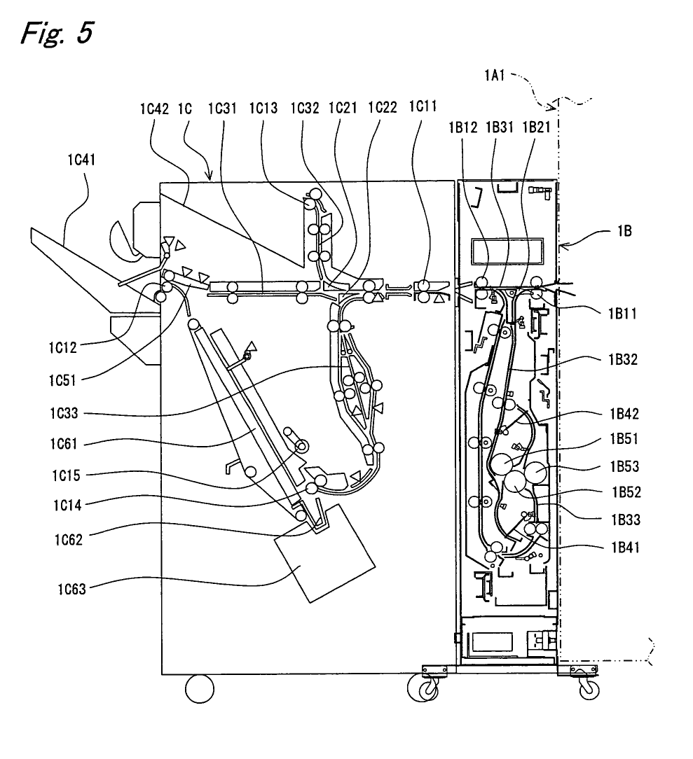

FIG. 5 is a schematic view showing the configuration of a folding machine and a finisher equipped to the image forming apparatus according to the present embodiment.

As shown in FIG. 5, folding machine 1B and finisher 1C are arranged on the flank (on the paper output side) of image forming apparatus 1A, folding machine 1B and finisher 1C being joined in series in this order from the upstream side with respect to the paper's direction of conveyance.

Folding machine 1B is a so-called z-folding machine for folding paper in three, in which, as shown in FIG. 5, the paper discharged from image forming apparatus 1A is lead into an entrance roller 1B11 into the machine, and passed through the machine without it being folded or folded inside the machine, in accordance with the command from image forming apparatus 1A.

In folding machine 1B, when the command from image forming apparatus 1A does not indicate z-folding, a branch guide 12B21 is set by an unillustrated solenoid so that the paper is guided along a first feed path 1B31 and linearly discharged by discharge roller 1B12 out of folding machine 1B.

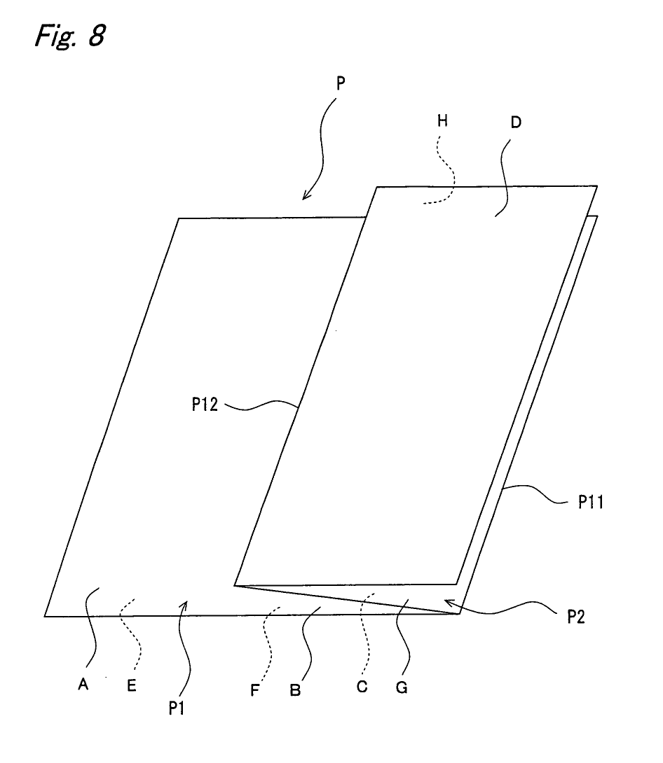

On the other hand, when z-folding is selected by the command from image forming apparatus 1A, branch guide 1B21 is set so that the paper is guided toward a second feed path 1B32 having a z-folding arrangement for implementing z-folding of a sheet of paper and conveyed until the leading end of the paper abuts a first stopper 1B41. As a result, the paper is flexed and a first fold P11 (see FIG. 8) located in the middle of the paper is guided toward the nip between first and second folding rollers 1B51 and 1B52 to form a first fold.

Thereafter, similarly, the leading end of the folded paper abuts a second stopper 1B42, so that a second fold P12 (see FIG. 8) is guided toward the nip between second and third folding rollers 1B52 and 1B53 to from a second fold.

Then, the paper passes through a third feed path 1B33 located downstream of second and third folding rollers 1B52 and 1B53, is discharged out of folding machine 1B by discharge roller 1B12 and fed to the side of finisher 1C that is joined on the paper output side.

Finisher 1C guides the paper discharged from folding machine 1B thereinto by means of an entrance roller 1C11, and passes the paper therethrough without processing the paper or performs a stapling process for binding sheets of paper by means of staples therein.

In finisher 1C, when non-staple mode is selected by the command from image forming apparatus 1A, the paper is introduced into the machine by entrance roller 1C11 so as to pass through branch guides 1C21 and 1C22 (normally, branch guides 1C21 and 1C22 are positioned along the direction of a non-staple feed path 1C31) and is discharged by a paper discharge roller 1C12 and stacked onto a vertically movable paper output tray 1C41. At this time, a paper output guide plate 1C51 is closed.

When cut-in tray output mode is selected at the control portion of image forming apparatus 1A, branch guide 1C21 rotates by a predetermined angle so that the paper is conveyed to a cut-in tray feed path 1C32 and discharged by a paper discharge roller 1C13 and stacked onto a cut-in tray 1C42.

When staple mode is selected at the control portion of image forming apparatus 1A, branch guide 1C22 is actuated so that the paper is fed into a staple feed path 1C33, and further discharged by staple tray discharge roller 1C14 and stacked onto a staple tray 1C61.

The paper discharged on staple tray 1C61 is tapped downward, sheet by sheet, by a tapping roll 1C15 so that the rear end of the paper is abutted on a paper rear end reference fence 1C62 and aligned thereto.

The sheets thus aligned are bound at one or two predetermined places at the rear end of the sheaf of paper by an end face binding stapler 1C63. The thus stapled sheaf of paper is raised up to paper discharge roller 1C12 by discharge claws (not illustrated) integrated with a discharge belt (not illustrated). The sheaf is then pressed against paper discharge roller 1C12 by paper output guide plate 1C51, and discharged by this paper discharge roller 1C12 and stacked on paper output tray 1C41.

Paper output tray 1C41 is arranged so that it can be moved up and down by an unillustrated driver, and is moved up and down in accordance with the stacked amount of discharged paper so that the paper to be discharged is discharged at the optimal position.

Next, characteristic image forming in image forming apparatus 1A of the present embodiment will be described with reference to the drawings.

To begin with, a case in which image forming apparatus 1A performs image output following a middle folding (folding in two) command of paper P will be described.

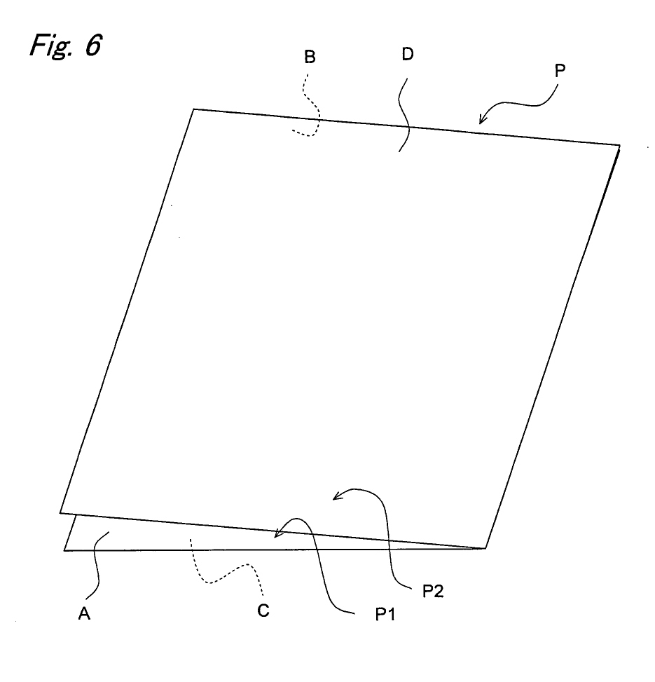

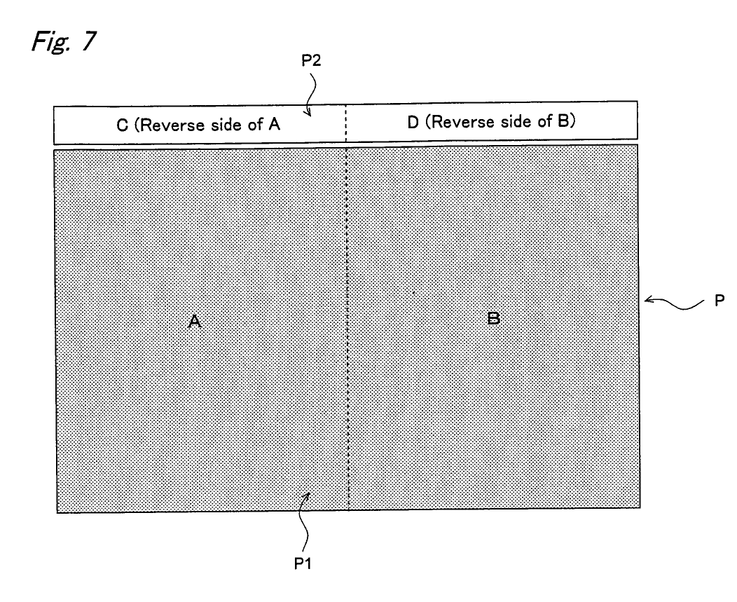

FIG. 6 is a perspective view showing one status example of the output sheet that is folded in accordance with a middle folding command in the image forming apparatus of the present embodiment. FIG. 7 is an illustrative view showing image forming areas on the sheet based on middle folding information in the image forming apparatus 1A.

When paper P is folded in the middle, one side (the first page) P1 to be located inside when paper P is folded in two, will be unseen since the opposing sides cover each other as shown in FIGS. 6 and 7. Accordingly, the images formed in the opposing sections A and B on the first page P1 located inside will not be seen from the outside because the opposing sides hide each other, hence it is possible to restrain leakage of the images.

On the other hand, the other side (the second page) P2 of paper P will be exposed outside when paper P is folded in two. Accordingly, the images in sections C and D on the second page P2, located on the back side of sections A and B on the first page P1 are exposed outside, so that it is impossible to prevent leakage of the images.

Accordingly, in image forming apparatus 1A, when image output is performed following a command of folding paper P in the middle or in two, image processor 57 sets image data such that important images (particular images) are laid out in sections A and B on the first page P1 side, and image forming portion 14 forms images on paper P based on that image data.

Since images are formed as above, it is possible to make the important images formed on sections A and B unseen from the outside by folding the paper P after image formation in the middle. In this way, it is possible to prevent leakage of important image information and keep the temporary security function.

Next, a case in which image forming apparatus 1A performs image output following a z-folding command of paper P (folding the paper in three) will be described.

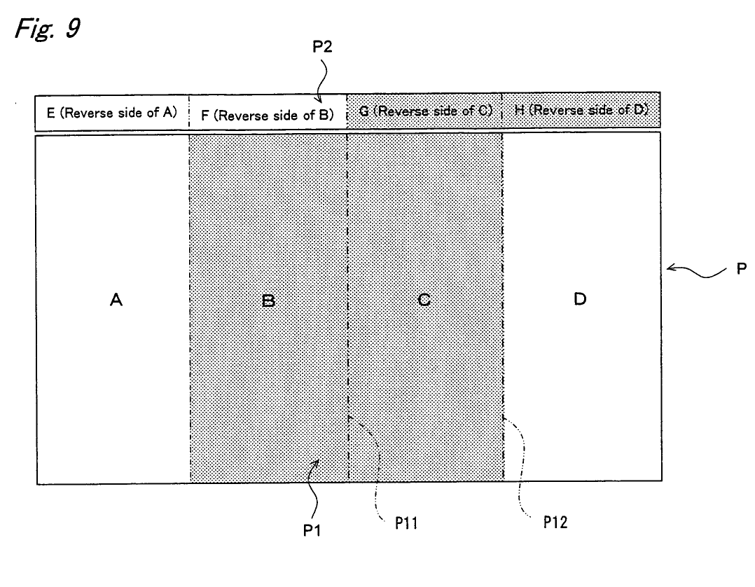

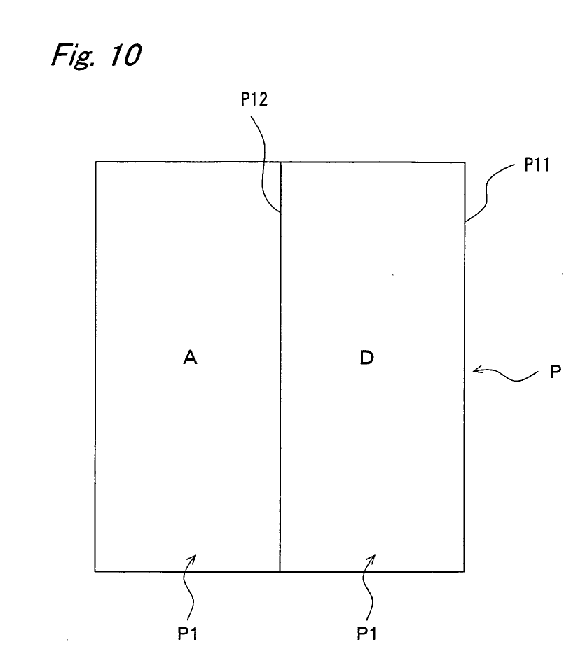

FIG. 8 is a perspective view showing one status example of an output sheet that is folded in accordance with a z-folding command in the image forming apparatus of the present embodiment. FIG. 9 is an illustrative view showing image forming areas on the sheet based on z-folding information in the image forming apparatus. FIG. 10 is a plan view showing a state of the sheet being folded.

When paper P is z-folded, there exist sections opposing inside and sections exposed outside in both sides (the first and second pages) as shown in FIGS. 8 and 9. That is, of sections A, B, C and D in the first page P1 of paper P, sections B and C oppose inside as shown in FIG. 9 while sections A and D are exposed outside as shown in FIG. 10. Accordingly, the images formed in sections B and C on the first page P1 of paper P will not be seen from the outside because the opposing sides hide each other, hence it is possible to restrain leakage of the images.

On the other hand, sections A and D on the first page P1 of paper P are exposed outside when paper P is z-folded. Accordingly, the images on sections A and D are exposed outside, so that it is impossible to prevent leakage of these images.

In the second page P2 of paper P, of sections E, F, G and H, sections G and H oppose inside as shown in FIG. 9 while sections E and Fare exposed outside. Accordingly, the images formed in sections G and H on the second page P2 of paper P will not be seen from the outside because the opposing sides hide each other, hence it is possible to restrain leakage of the images.

On the other hand, sections E and F on the second page P2 of paper P are exposed outside when paper P is z-folded. Accordingly, the images on sections E and F are exposed outside, so that it is impossible to prevent leakage of these images. However, when one-sided printing, image forming is performed on the first page P1 of paper P only, so there occurs no leakage problem as a result of exposure of sections E and F.

Accordingly, in image forming apparatus 1A, when image output is performed following a command of z-folding paper P, image processor 57 sets image data such that important images (particular images) are laid out in sections B and C on the first page P1 side and in sections G and H on the second page P2 side, and image forming portion 14 forms images based on that image data.

Since images are formed as above, it is possible to make the images formed in sections B and C on the first page P1 and in sections G and H on the second page P2 unseen from the outside by z-folding paper P after image forming. In this way, it is possible to prevent leakage of important image information and keep the temporary security function.

Since in the present embodiment, image forming apparatus 1A includes folding machine 1B, based on a folding command (folding information) as described above it is possible to form particular images in particular locations of paper P in accordance with the folding command and then automatically fold and discharge the paper in accordance with the folding command by means of folding machine 1B. As a result, it is possible to automatically discharge paper P in such a state that important image information will not be seen from the outside.

Further, when, in image forming apparatus 1A, image processor 57 is adapted to add copy restraint information or copy prohibition information to sections A and B in the first page P alone, it is possible to achieve doubled safety measures, or both physical security and electric security, hence provide further improved security.

Further, when, image forming apparatus 1A, upon laying out images by image processor 57, part of the inside page sections of paper P that will be folded is set with copy prohibition/permission information, it is possible to add a simplified security function.

According to the present embodiment thus constructed, image processor 57 sets particular images in particular locations in accordance with the way in which paper P is folded (folding information) so as to form the particular images at positions that are unseen from the outside when paper P is folded. Accordingly, it is possible to make the particular images unseen after paper P has been folded, whereby it is possible to prevent leakage of image information on paper P after it has been formed with images and discharged from image forming apparatus 1A and hence improve security.

Having described the preferred embodiments of the present invention, the present invention should not be limited to the above-described embodiment, and various changes can be made within the scope of claims. That is, any embodied mode obtained by combination of technical means disclosed by the above embodiment modes should be included in the technical art of the present invention.

For example, in the above embodiment, the present invention is applied to a monochrome image forming apparatus, however the present invention should not be limited to the image forming apparatuses and copiers having the above configuration. That is, the present invention can also be applied to a color image forming apparatus (multifunctional machine, printer, etc.) as long as it includes an image process that can convert image information into image data.

What is claimed is:

1. An image forming apparatus that is controlled to perform image output based on electrophotography, comprising:
an image processor for outputting input image information in the form of image data for forming images; and,
an image forming portion for forming images on recording paper based on the image data output from the image processor,
characterized in that the image processor has a function which, in accordance with folding information for folding recording paper with images formed thereon, sets the images to be formed on the page of the folded recording paper whose folded sections oppose each other when the recording paper has been folded.

2. The image forming apparatus according to claim 1, wherein the folding information is information for folding the recording paper in two.

3. The image forming apparatus according to claim 1, wherein the folding information is information for folding the recording paper in three.

4. The image forming apparatus according to claim 1, wherein the images formed on the page of the folded recording paper whose folded sections oppose each other is based on particular image information of the image information input to the image processor.

5. The image forming apparatus according to claim 1, wherein the images formed on the page of the folded recording paper whose folded sections oppose each other is based on the image information obtained from an external device.

6. The image forming apparatus according to claim 1, wherein the image processor has a function of adding copy restraint information to the page of the folded recording paper whose folded sections oppose each other.

7. The image forming apparatus according to claim 1, wherein the image processor has a function of adding copy prohibition information to the page of the folded recording paper whose folded sections oppose each other.

8. The image forming apparatus according to claim 1, further comprising: a folding mechanism for folding the recording paper after image forming.
